(19) United States
(12) Patent Application Publication
(10) Pub. No.: US 2001/0037241 A1
(43) Pub. Date: Nov. 1, 2001

(54) System and method for providing e-commerce based on a reward currency

(76) Inventor: Deepak Puri, Mississauga (CA)

Correspondence Address: EUGENE J A GIERZAK, KEYSER MASON BALL, 201 CITY CENTRE DRIVE, SUITE 701, MISSISSAUGA, ONTARIO, L5B 2T4, CA

(21) Appl. No.: 09/815,283

(22) Filed: Mar. 23, 2001

Related U.S. Application Data
(60) Provisional application No. 60/191,477, filed on Mar. 23, 2000.

(51) Int. Cl. G06F 17/60

(52) U.S. Cl. 705/14

(57) ABSTRACT

A system, computer product and method are provided for designing, creating, implementing and managing incentive programs based on a reward currency in association with an interconnected network of computers. The system, computer product and method provided further comprises an e-commerce facility for processing electronic transactions based on the reward currency.

### FIELD OF THE INVENTION

The present invention relates generally to an on-line computerized incentive system based on a method for transacting business over an into-connected network of computers using a reward currency. The present invention relates more particularly to an e-commerce system providing an environment in which business-to-business and business-to-individual transactions attract allocation of a reward currency. The present invention still further relates to a computerized incentive system which is responsive to user customization. The present invention still further relates to a method for providing incentive program design and management services over an inter-connected network of computers.

### BACKGROUND OF THE INVENTION

Incentive programs are typically offered by sponsoring companies to promote sales of their goods or services, or to improve the performance of their employees. For example, employees participating in incentive programs generally receive credits that can be accumulated and exchanged for merchandise in award catalogues, or for travel awards. The selling price of individual items of merchandise are therefore stated as credit values instead of dollar amounts.

Similarly, frequency programs have been developed by the travel industry to promote customer loyalty. An example of such a program is a “frequent flyer” program. According to such program, when a traveller books a flight, a certain amount of “mileage points” is calculated by a formula using the distance of the destination as a parameter. However, the mileage points are not awarded until the traveller actually takes the flight. When a traveller has accumulated sufficient number of mileage points, s/he may redeem these points for an award chosen from a specific list of awards specified by the program. While this program may induce customer loyalty, it has the disadvantage that the selection of prizes can be made only from the limited list of awards provided by the company.

According to another type of frequency and award program, a credit instrument is provided and credit points are accumulated instead of mileage points. Upon each purchase, a certain number of bonus points is awarded, which translate into a dollar credit amount. According to such programs, the customer receives a credit instrument, which may be accepted by many enrolled retailers, so that the selection of prizes available is enhanced. An example of such a program is disclosed in European Patent Application 308,224. However, while such programs may enhance the selection of prizes, there is still the problem of obtaining the credit instrument for redeeming the awarded points. In addition, the enrollee must allow for processing time before the bonus points are recorded and made available as a redeemable credit. Thus, the immediacy effect of the reward is lacking in such conventional incentive programs.

Such incentive programs are often designed and managed by businesses such as MARITZ™ and others. Customized incentive programs are provided based on know-how in the domain of marketing, including the science of analyzing and predicting market responses. However, purchasing services related to such design and management of incentive programs can be quite costly. There is therefore a need for providing a utility which provides the know-how and tools required for businesses to design and manage their own incentive programs. Management of such incentive programs will preferably occur on an automated or quasi-automated basis.

Furthermore, there is a need for incentive programs with improved “immediacy effect”, i.e. the desired behaviour is rewarded in a fashion that is as immediate as possible having regard to time, and also in that the process by which the reward is provided makes the desired behaviour very clear to the user. This “immediacy” effect is greatly enhanced by providing incentive programs based on a “reward currency” rather than “reward points” as explained below.

Internet sites which create, provide, assign and manage redeemable points tied to specified transactions are known. For example, U.S. Pat. No. 6,009,412, issued to Thomas W. Storey on Dec. 28, 1999 for a “Fully integrated on-line interactive frequency and award redemption program”. According to this invention, a user may access the program on-line and may browse a product catalog for shopping. The user may electronically place an order, upon which the program automatically checks the user's credit and electronically issues a purchase order to the supplying company. The program also calculates award points, updates the award account of enrolled users and communicates that number of awarded points to the user. Enrolled users may browse through an award catalog and electronically redeem an amount of awarded points towards an award. The program then electronically places an award redeeming order with the fulfillment house and updates the user's award account.

The above invention does not provide for design of customized award programs, or on-going customization thereof. Nor does the above invention disclose means for providing a “reward currency” for improved “immediacy effect” as further explained below.

In view of the above, it is clear that there is also need for an incentive program, and utility for designing and managing same, which are based not on “reward points”, i.e. points which can be redeemed when collected having regard to specific products or services for the full “reward point value” of specific products or services. Rather, there is a need for an incentive program which is based on a “reward currency”, i.e. a currency which results from transactions which are encouraged in a market environment, but which are treated as a currency, i.e. they can be used to purchase products and services of a great variety (i.e. not only the group of products in relation to which the “reward currency” has been accumulated), and more importantly which can be used to purchase a product in addition to traditional currency, thus functioning as a means for discounting the price of a product or service in traditional currency. In this way, the “reward currency” functions more as a traditional currency than “reward points.”

There is also a need for an incentive program, and utility for designing and managing same, where the immediacy effect is optimized by allowing traditional currency to be converted into “reward currency” thereby permitting the desired reward to be obtained without delay where there is insufficient “reward currency” to make the purchase of the desired good or service immediately. There is also a need for an incentive program where the “immediacy effect” is further enhanced by the fact that the market environment in which “reward currency” is distributed is immediately responsive to the desired consumer or business behaviour (e.g. purchase of a product or service).

There is also a need for an incentive program, and utility for designing and managing same, where the “immediacy effect” is realized by enabling users to respond to good and service offerings on a “real time” basis and using, for example, portable electronic devices, allocating “reward currency” based on desired user behaviour also in “real time” and permitting transactions based on such allocated “reward currency” using such portable electronic devices.

There is also a need for a utility for designing and managing scalable incentive programs where the utility is flexible enough to allow smaller businesses and organizations to be able to create and administer customized incentive programs.

### SUMMARY OF THE INVENTION

The present invention is advantageous in that it provides pricing flexibility embedded in the system through a technical application that allows the user to pay for a selection of goods/services with traditional currency, “reward currency” or a dynamic combination of both.

Another advantage of the subject invention is that it employs an open system that promotes competition by allowing more and more users to experience the benefits of reward psychology without any qualifying criterion as found with several existing systems. Qualifying criterion may include transaction size, number of employees or start-up costs.

Another advantage of the present invention, which is derived from its ability to change parameters of an incentive program is that it allows its users to achieve a dynamic fit between the perceived value, needs and capacity of their target audience.

A still other advantage of the present invention is that it allows users to retrieve and respond to time-sensitive good/service requisitions or offerings using portable devices; further to retrieve allocation of “reward currency” based on desired behaviour in regard to such good/service requisitions or offerings; and still further to permit immediate transactions using such allocated “reward currency”.

The present invention is further advantageous in that its flexibility allows it to be employed to create and administer a wide variety of incentive programs, be they employee programs, business to business model programs, or business to end user model programs.

Yet another advantage of the present invention is that it allows registered users to educate themselves in the online environment and launch a campaign at their convenience twenty-four hours a day, 7 days a week. The system disclosed herein also permits registered users to view reports provided regarding the impact on market behaviour by the web-site of the present invention, as well as to make adjustments to their campaign based on the contents of such reports.

### BRIEF DESCRIPTION OF THE DRAWINGS

A detailed description of the preferred embodiment(s) is(are) provided herein below by way of example only and with reference to the following drawings, in which:

FIG. 1 is a system resource flowchart illustrating the resources of the preferred embodiment of the system described herein;

FIG. 2 is a process flowchart illustrating the method for gaining access to the control panel, as well as functionality accessible through said control panel of the preferred embodiment herein;

FIG. 3a is a flowchart illustrating the functions of the Incentive Customization Facility of the preferred embodiment of the system described herein;

FIG. 3b is a further flowchart illustrating the functions of the Incentive Customization Facility having regard to incentive programs designed for business-to-business and business-to-customer transactions;

FIG. 3c is a still further flowchart illustrating the functions of the Incentive Customization Facility having regard to incentive programs design for employee incentive programs;

FIG. 4a is a further flowchart illustrating the requisition feature provided by the Launch Incentive Program Facility;

FIG. 4b is a still further flowchart illustrating in greater detail the Precise Method requisition feature of the Launch Incentive Program Facility;

FIG. 4c is another flowchart illustrating in greater detail the Open Method requisition feature of the Launch Incentive Program Facility;

FIG. 4d is another flowchart illustrating additional features of the Launch Incentive Program Facility;

FIG. 5 is a flowchart illustrating some of the functions of the E-commerce Facility and Incentive Management Facility;

FIG. 6 is a flowchart illustrating some of the resources and functions of the E-commerce Facility; and

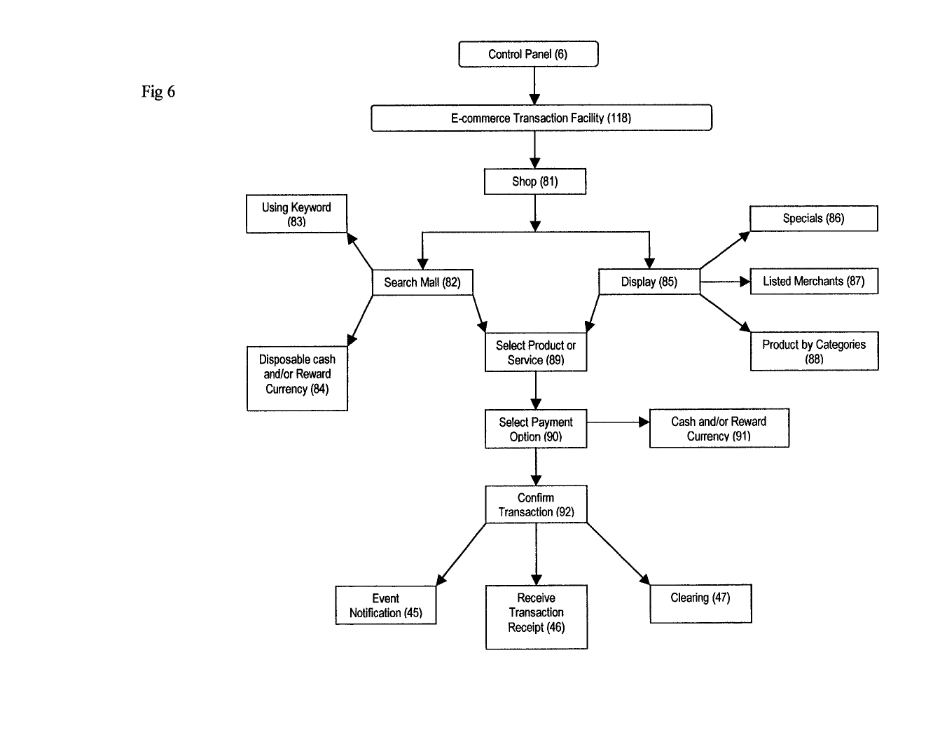

FIG. 7 is a flowchart illustrating some of the functions of the Reporting Facility.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE EMBODIMENT

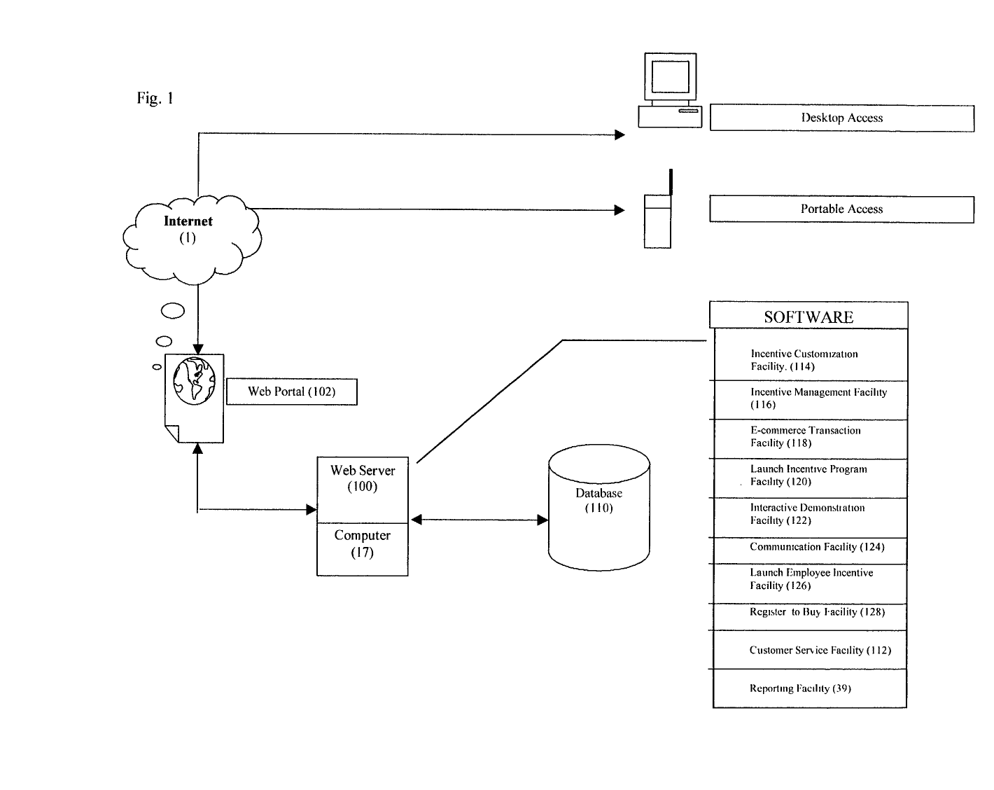

Referring to FIG. 1, there is illustrated in a system resource flowchart showing the principal components of the preferred embodiment of the present invention.

In the preferred embodiment of the invention as shown in FIG. 1, the Internet 1 or other networks of inter-connected computers will be the principal medium through which the various “users” will interact and transact with the system of the present invention.

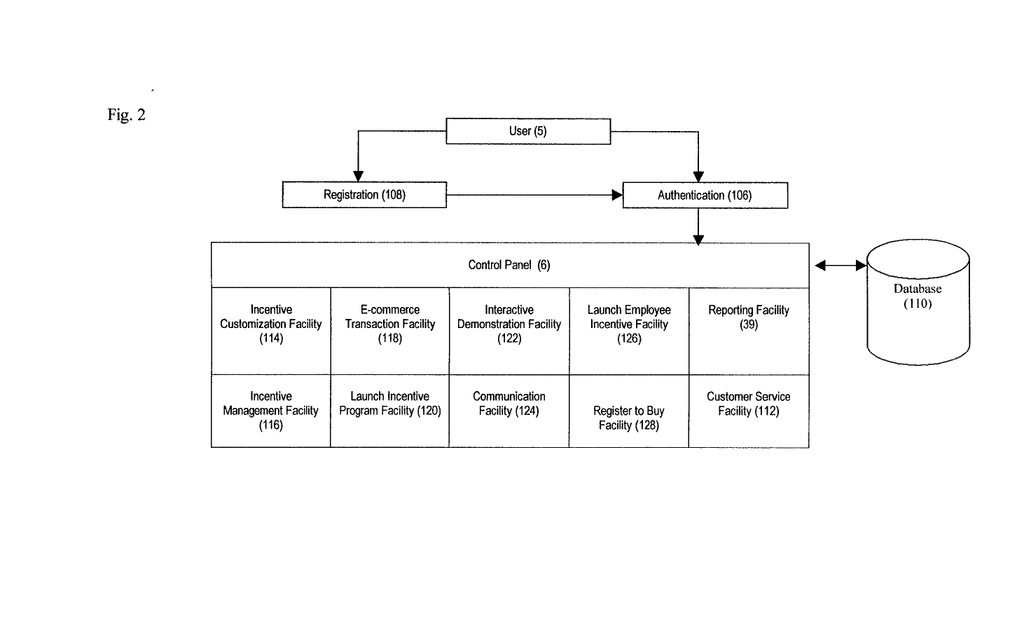

For the sake of clarity, “user” in this invention applies to any individual or corporation who has undergone the registration process 108 shown in FIG. 2 and is therefore entitled to participate in the environment created by the system described herein. Each individual user may or may not be an employee participating, for example, in an employee incentive programs being provided by the system described herein. Each business and individual user may also be a buyer or seller of goods/services.

The connection to the Internet or other networks of inter-connected computers can occur in a variety of ways, including by telephone line, fiber-optic cable, coaxial cable, datalink, satellite, etc.

As shown in FIG. 1, the user interfaces with the system of the present invention by means of a server 100 which communicates with the Internet. Said server 100 comprises the incentive customization facility 114, incentive management facility 116, e-commerce facility 118, launch incentive program facility 120, interactive demonstration facility 122, communication facility 124, launch incentive program facility 126 register to buy facility 128 and computer 129.

The user accesses a web portal 102 and associated plurality of web pages (not shown) which is provided by server 100 and which allows each user to access the numerous portions of such web pages. For reasons which will be explained later, this web portal 102 will ideally include a number of tools for accessing specific areas of the web site, including a number of tools such as directories, search engines, brand-name based locating engines, and so on.

To access numerous portions of the web site, however, an authentication routine 106 will have to be completed by user. This routine is best shown in FIG. 2. This is achieved using dialogue boxes allowing the user to enter a username and password, or, alternatively, there will be a link that users can click in order to obtain a user name and password by way of a registration routine 108, also as best shown in FIG. 2. The user is asked to enter varied information such as their business and contact information. Once a user has completed the registration routine 108, the user is assigned a user name and password that is displayed on a subsequent web page. The web page contains a link back to the original authentication routine page, and the user will now be able to enter their user name and password in the dialogue boxes on that page. Each registered user name corresponds to an identification number to be used in all areas of the system. Once the user has entered their user name and password on the authentication routine page, the information is sent to the computer for verification in association with database 110 to ensure that the username and password correspond with the data stored on database 110. If the data corresponds, then the user will be granted access to the control panel 6.

Control panel 6 which is best shown in FIG. 2 comprises a graphical and textual menu which affords access to the various functions of the system described herein and provides essentially a navigation bar for accessing the various functions provided by the system described herein. Through registration process 108 the needs of each user will be determined. For example, a user who merely wants to purchase goods/services in the environment provided by the system described herein and thereby earn “reward currency” will not require access to the incentive customization facility 114. Therefore not every user will require access to all of the features of the system and computer product described herein. Therefore the system and computer product described herein preferably provides means for tailoring control panel 6 to conform with the particular requirements of the particular user, in a manner that is well known.

It should also be understood, that the particular control panel 6 of a particular user can be further tailored by the system described herein by customizing the content of said control panel 6 to the particular requirements of each user as may be extrapolated over time from the manner in which the particular user makes use of the system described herein, in a manner well-known to those skilled in the art. Relevant data regarding such user might include, for example, spending habits, navigation patterns, etc. Such customized content may include display advertising in relation to goods/services available via the system described herein which is likely to be of interest to the particular user based on such relevant data regarding the user.

Also, the system described herein will be able to discern whether the user is an employee, a customer or a business or organization, and will tailor the advertising displayed accordingly.

As best shown in FIG. 2, in the case of some users, control panel 6 will give access to the incentive customization facility 114, incentive management facility 116, e-commerce facility 118, launch incentive program facility 120, interactive demonstration facility 122, communication facility 124, register to buy facility 128 and customer service facility 112. The attributes of each such facility is described below.

To enter any of these areas, the user will select the graphical or text-based link that accesses said facility. In the case where control panel 6 is not tailored to the particular user, users who are not authorized to use a selected area will receive a message stating that they do not have access to that particular area, and to try another. It should be understood that the present invention also contemplates numerous other arrangements and/or tools for accessing the functionality provided by the system described herein and/or navigating within web portal 102 and the web pages.

### Incentive Customization Facility

Once a user who is authorized to use incentive customization facility 114 has selected the link into same, such authorized user will be invited to “CREATE AN INCENTIVE PROGRAM”.

As best shown in FIG. 38a, the user can choose to either build an incentive program from the bottom up 28, or rely on a series of incentive program templates provided by the system described herein based on business market profiles organized in directories.

If the user chooses to rely on the incentive program templates provided by the system, then, user is requested to indicate whether the incentive program is directed at employees 25 or business to business or business to end user/customer relationships 26.

Then, the user is requested for information regarding the type of behaviour which the user wishes to encourage and the target audience for the incentive program. This is important because the system described herein will provide market templates designed for particular market segments and directed at a particular target audience. For example, the incentive program features described below which are included in the incentive program templates will be different depending on whether the user wishes to encourage repeat sales of automobiles, or purchase of extra warranties on computer products.

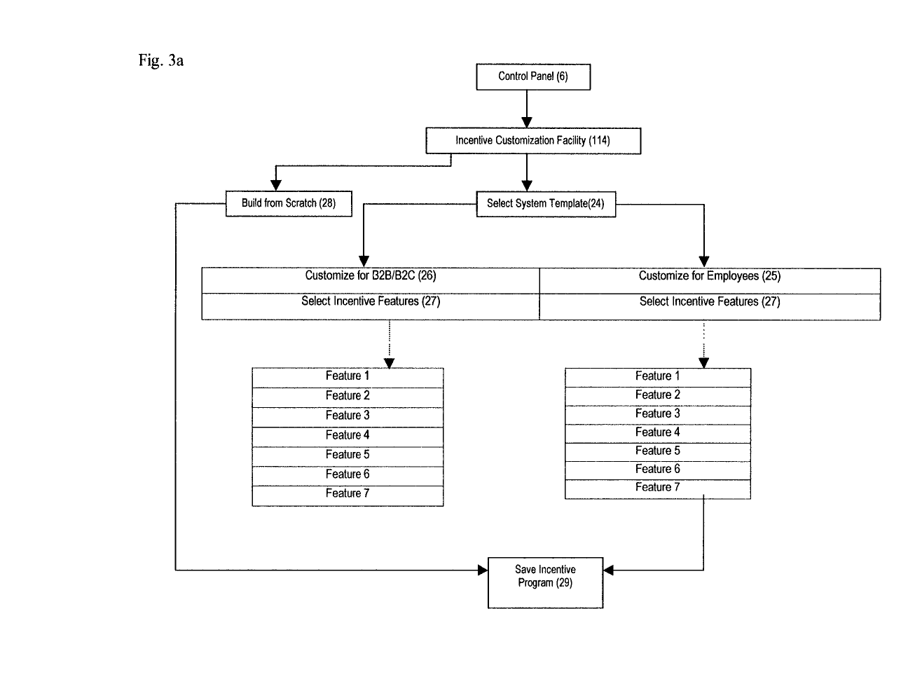

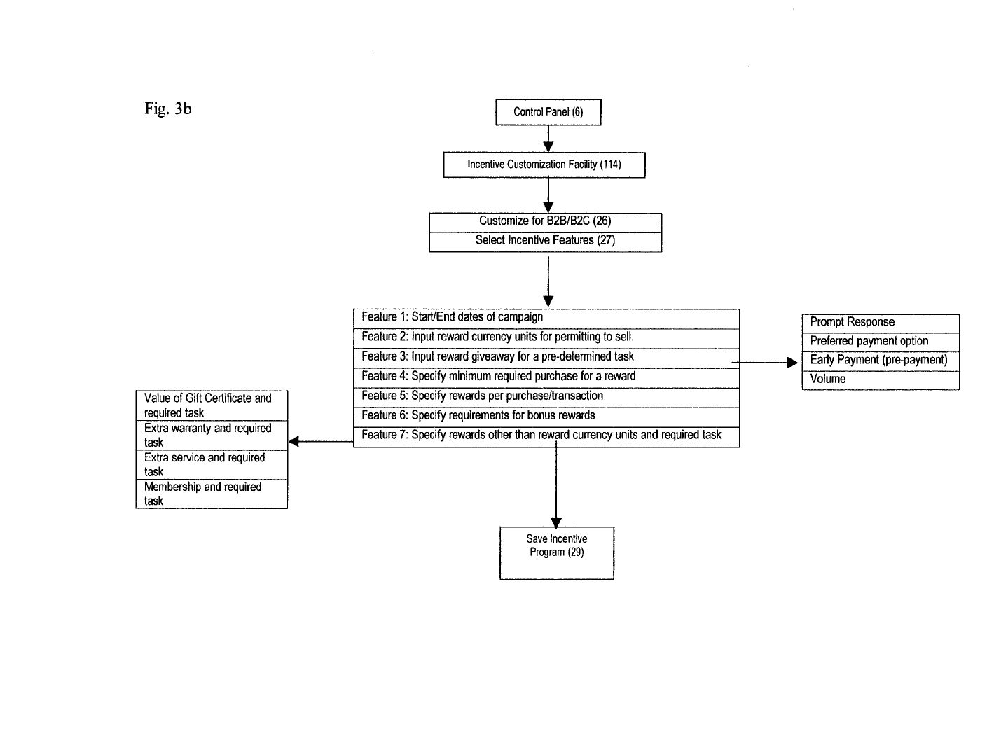

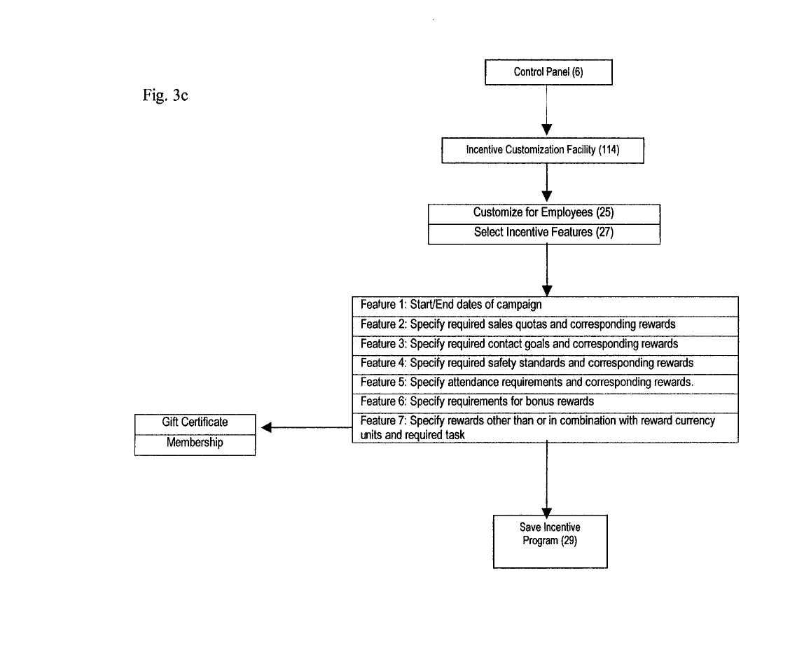

Once the selection is made having regard to market segment and target audience, as outlined above, users are provided with a series of drop-down menus from lists of specific incentive program features 27 which are determined to be optimal for the particular market segment and target audience in which user is interested. These features include start and end dates of programs, award values for certain rewardable behaviours of a particular incentive program, market segment area, etc. Some of these features are illustrated in FIGS. 3b and 3c. It should be understood that the list of features provided is not exhaustive, and again will depend on the market segment and target audience, as mentioned above.

A field corresponds to each of such features, requiring the user to select options including numerical values, as the case may be. For example, as shown in the particular optimal incentive program presented by incentive customization facility 114 illustrated in FIG. 3b, “Feature 4: Specify minimum required purchase for a reward” requires the user to enter a dollar amount or quantum of goods/service purchased corresponding to such minimum required purchase, as the case may be.

In the case of each optimal incentive program presented by incentive customization facility 114, the user may require that additional features be added to such optimal incentive program, or some features provided be removed. Incentive customization facility 114 will present to the user a list of additional features which may be added electronically to the optimal incentive program selected by the user by some form of electronic selections means, as is well-known to those skilled in the art. Of course, such additional features will also require the input of numerical or other value as described above.

Database 110 contains data providing extensive know-how regarding the design and management of incentive programs. Particular segments of this data with regard to particular features can be selected, retrieved and made available to the user, whether in text, voice or video format. This data can be provided, for example, using a graphic help utility which offers data menus depending on the location of the user's cursor at any given time. For example, when determining “Start/End dates of campaign” in accordance with Feature 1 of FIG. 3b, this graphic help utility would offer a menu of data regarding, for example, necessary lead time for taking advantage of the Christmas season in a retail environment.

It is also contemplated that incentive customization facility 114 described herein will also, during the course of the creation of user's customized incentive program, make available to the user case studies regarding the success of particular incentive programs for particular market segments and/or for particular business objectives.

Conversely, if the user chooses to build its incentive program from the bottom up 28, or wishes to include a feature that is not provided for electronic selection as described above, a customer service representative linked to the system described herein will be engaged. Based on specifications provided by the user, such customer service representative will customize the incentive program template to provide electronically the desired features(s), in a manner well-known to those skilled in the art.

Once the incentive program has been finalized, whether through select system template 24 or build from scratch 28 as shown in FIG. 3a, the incentive program will be uploaded to incentive management facility 116, by clicking on the “SAVE INCENTIVE PROGRAM” 29. The features of incentive management facility 116, are described below.

It follows from the invention described herein, that it is desirable for the user to be able to customize incentive programs not only when they are designed, but also on an on-going basis. If the user has already created incentive programs, control panel 6 will provide links giving various reporting options on all transactions to date in the context of such incentive programs. Through a series of drop-down menus and dialogue boxes, a user will also be able to change the award values, add new rewardable behaviours, and add new employees or businesses that will be participating in the incentive programs, thus allowing for the ongoing customization of the users' incentive programs. Once the user has completed entering or adjusting the information relating to their incentive program, s/he will be able to click the “SAVE INCENTIVE PROGRAM” prompt 29. This will allow the user to save the incentive program and thus change their program parameters in real time.

For example, if the incentive program in question is an employee incentive program, the user will be able enter all data regarding rewardable behaviour which is intended to elicit allocation of “reward currency”, and how frequently, when and in what amount. After the information has been entered for each rewardable behaviour, the user will click the “SAVE INCENTIVE PROGRAM” button 29 which will send the information to the database 110 wherein the information is stored in the appropriate user profile which is associated with the particular user requesting the employee incentive program in question.

It should be understood that reporting facility 39 can be engaged by the user within the incentive customization facility 114 by means of control panel 6, in order to generate reports on the effectiveness of particular incentive programs within given time periods, and analyze such reports. Based on such reports and analysis, the user may wish to make adjustments to the parameters provided for the incentive program in question, as described above. The specific features of the reporting facility 39 are discussed below.

It should also be understood that the interactive demonstration facility 122 can be engaged by the user within the incentive customization facility 114 in order to predict the effectiveness of an incentive program given particular parameters set by the user, and make adjustments to such parameters if same appear justified based on the demonstration provided by said interactive demonstration facility 122.

### Launch Incentive Program Facility

The system described herein further comprises launch incentive program facility 120. The role of this facility is to provide the user with the necessary tools to launch an incentive program in the environment created by the system, once an incentive program has been customized using incentive customization facility 114.

Launch incentive program facility 120 comprises a series of web pages accessible to users who are registered for running an incentive program via the system. These pages allow users to purchase banner space at specified locations in the environment created by the system, with banners of specified size, positioning, formatting, content etc. Launch incentive program facility 120 also permits users to advertise their incentive program by having such program listed in directories at specific locations in the system environment, having such programs entered into search engines for the system environment etc. Also, said launch incentive program facility 120 also permits users to purchase advertising in other media controlled by the system owner such as print publications, web channels, billboards and the like. Depending on the parameters set by individual users in the registration process described above 108 having regard, for example, to their interest in particular good/service offerings, the user may request (for free or for consideration) the system operator to advertise the incentive program via e-mail or otherwise to all or specified users of the system.

It should also be understood, that launch incentive program facility 120 also provides the user with means for promoting their incentive program in media not controlled by the system operator. For example, the web pages provided by launch incentive program facility 120 can also permit the user to purchase banners on external web sites or print ad publications in magazines not controlled by the system operator. In the same way, launch incentive program facility 120 can provide user with means for listing their incentive program with third party directories and/or search engines.

Launch incentive program facility 120 also provides templates for creating press releases regarding a user's incentive programs. These templates allow users to select from a variety of formats, text templates, graphics etc. Also, system operator will maintain a list of potential third parties likely to be interested in such press releases. Once user's press release is finalized and sent to server, the press release will be published at pre-arranged locations within server environment, and also made available through communication facility 124 to such potential third parties. These potential third parties might include on-line or off-line publishers of all kinds.

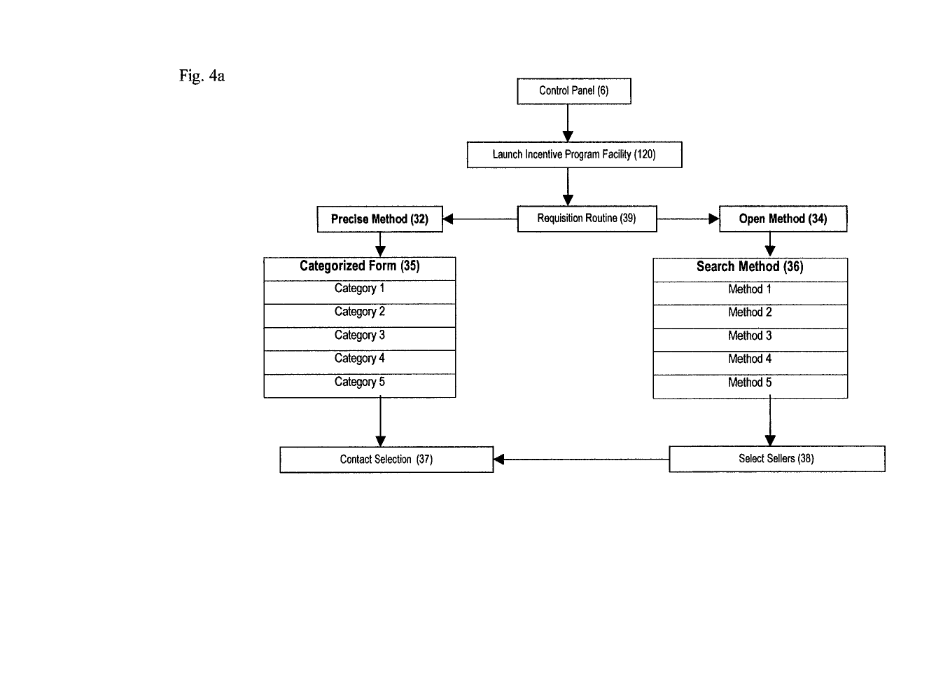

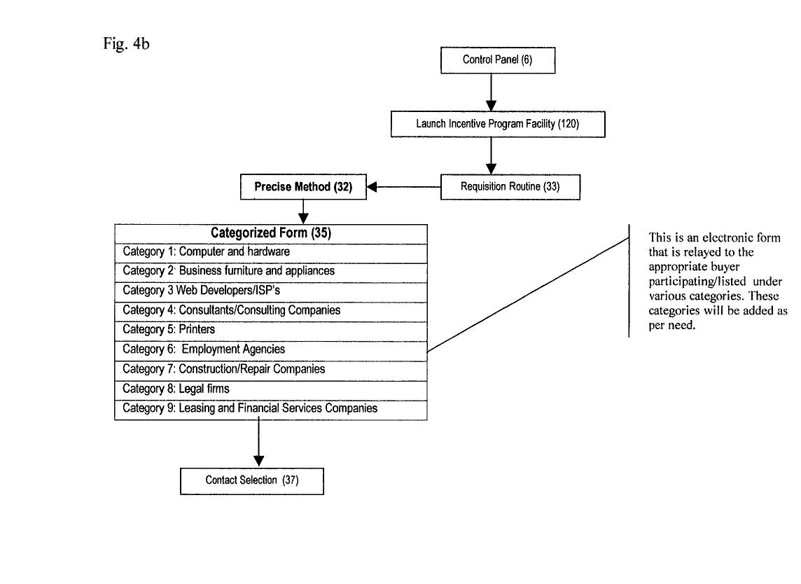

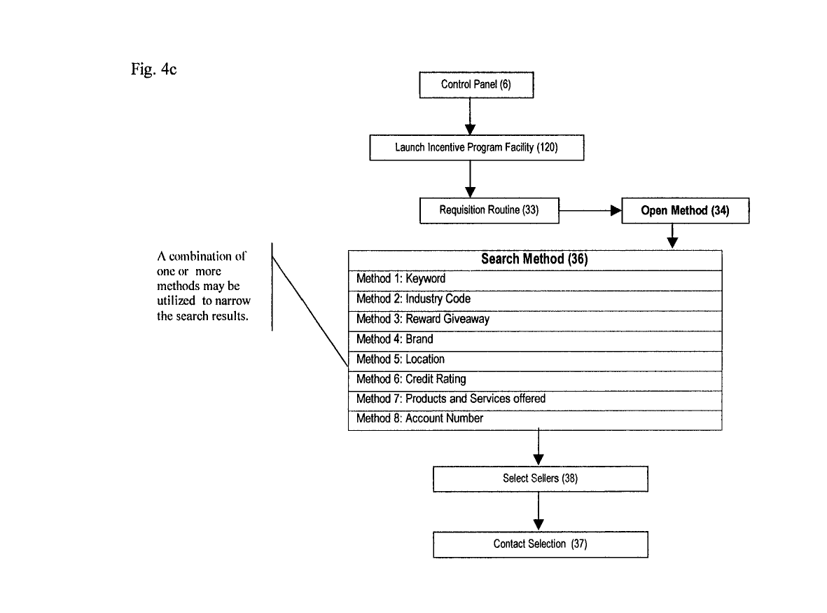

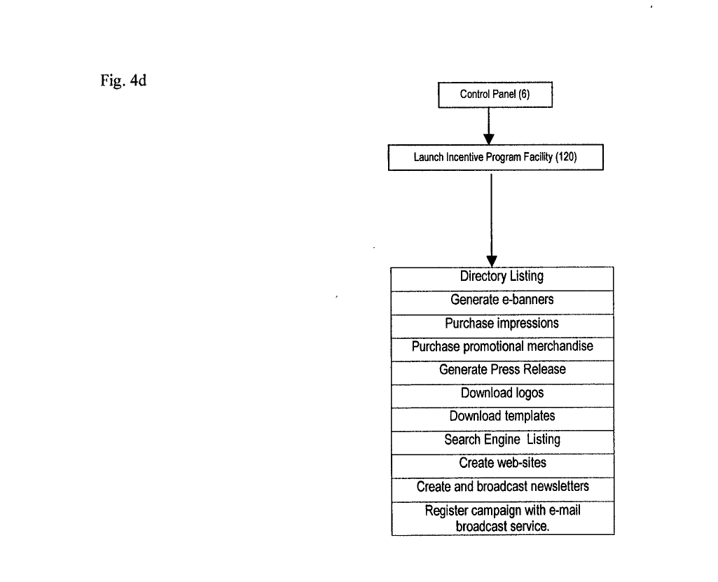

Some incentive programs will be tied to forms made available to other users of the system. These forms may relate to good/service offerings or good/service requisitions. Templates for creating such forms are also available to users through the launch incentive program facility 120. These templates may be determined by the category of good/service which the user is offering to other users. FIG. 4b illustrates the process by which such categorized requisition forms 35 are made available to users. FIG. 4c illustrates a process for creating a more precise requisition form. It should be understood that FIG. 4b and FIG. 4c merely illustrate a sample of possible requisition forms or search techniques.

As explained further below, the launch incentive program facility 120 co-operates with register to buy facility 128 to make, for example, such good/service requisitions available to potential sellers. Also, as explained below, launch incentive program facility 120 also co-operates with e-commerce facility 118 whereby said good/service requisitions are made available in said e-commerce facility 118, by means of directories, search engines and the like.

In addition, users who are sellers may also be notified of said goods/services requisitions automatically by the server of the present invention. Such sellers will have indicated previously during the registration process 108 the particulars of their desired goods/services provision within the server environment. The server of the present invention, in co-operation with launch incentive program facility 120, provides a search engine based matching process to match potential buyers with corresponding potential sellers. On the basis of said matching process, the server of the present invention will inform such sellers of relevant goods/services requisitions in co-operation with communication facility 124. System operator may wish to allocate “reward currency” of a specified amount to each such buyer who submits said goods/service requisition.

In the case of a goods/services offering, the offering is also matched with potential buyers in accordance with a matching process corresponding to the process described above. System operator may wish to allocate “reward currency” in a specific amount where such an offering is submitted to the system operator, particularly when the offering relates to products/services for which there is a strong demand.

Also, by means of launch incentive program facility 120, the user can also purchase promotional goods (such as mugs, fridge magnets, t-shirts and the like), as well as place an order for such promotional goods which are customized, including by providing to launch incentive program facility 120 specifications and graphics for such customization.

The launch incentive program facility 120 will also provide, in the invention described herein, the medium where the user purchases “reward currency” to fund the incentive program. This purchase can be made by major credit card or invoice.

Still further, user may via launch incentive program facility 120 purchase a specific web area within the environment provided by e-commerce facility 118 for promoting the incentive program and providing an interface for processing transactions to which the incentive program applies. Launch incentive program facility 120 also provides means for user to incorporate into such specific web area functionality provided by a wide assortment of e-commerce tools (such as on-line catalogues, business-to-business tools, ordering management, EDI processing tools etc.), standard web designs, text templates and the like. Customer service representatives are available for providing custom content of any kind for such a specific web area, whether this relates to custom marketing copy, custom graphics, custom web content or custom e-commerce tools.

Rather than simply rely on the e-mail of, for example, a press release related to user's incentive program, as described above, the user may wish to search for other registered users who are likely to be potential purchasers of its goods/services and then contact them directly, whether electronically by phone etc. In some cases, the user may wish to send a promotional package to such potential purchasers which may include the promotional goods described above.

Again, through the registration process 108, users will be asked to indicate their interest in particular types of good/service offerings or promotions overall. This information will be subsumed into a search engine which is accessible to user through the launch incentive program facility 120. User therefore can obtain hits of potential purchasers and move forward with their promotional efforts, once server provides the contact information of such potential purchasers to user from database 110.

### Register to Buy Facility

The system described herein also comprises a register to buy facility 128. This facility permits users to submit to the system described herein a requisition for goods/services. The system may provide users with a template requisition form for providing information such as goods/service specifications, preferences regarding payment, shipping, location or size of goods/services provider etc. These forms include a “SEND” function which permits same to be posted to “REGISTER TO BUY” web pages in the server environment.

These forms are accessible to potential sellers in a variety of ways. The “REGISTER TO BUY” web pages themselves may include directories and search engines for locating particular goods/services requisitions based on a variety of search criteria such as key words describing goods/services, date of posting of goods/service requisitions, SIC code, dollar amount of contract, credit rating of potential buyer etc.

Users who are sellers may also be notified of goods/services requisitions automatically by the server of the present invention. Such sellers will have indicated previously during the registration process 108 the particulars of their desired goods/services provision within the server environment. The server of the present invention, in co-operation with register to buy facility 128, provides a search engine based matching process to match potential buyers with corresponding potential sellers. On the basis of said matching process, the server of the present invention will inform such sellers of relevant goods/services requisitions in co-operation with communication facility 124.

Whether the seller is informed of the potential buyer by the matching process described above, or by interfacing with register to buy facility 128, when seller finds potential buyer s/he may submit a goods/services offering corresponding to potential buyer's goods/services requisition. The goods/services offering is also produced by operation of launch incentive program facility 120, as described above. This offering is communicated to the potential buyers selected by seller in co-operation with communication facility 124. The offering may include a variety of information such as seller's profile, information (including photographs) of principals, mission statement, quality standards, shipping capabilities, description of experiences, service offerings, warranty information, payment terms, client testimonials, industry standard or accreditations etc. The offering will also include a “ACCEPT COMMUNICATION” button or equivalent which when clicked by buyer indicates to seller, in co-operation with communication facility 124, that buyer has agreed to seller contacting buyer, whether via telephone, e-mail or otherwise.

It should also be understood that allocation of “reward currency” may be tied to a number of events surrounding the processes administered by register to buy facility 128. For example, server operator may wish to encourage potential buyers to register to buy via register to buy facility 128. Accordingly, the “reward currency” account of each user who registers in this way may be credited with a specific “reward currency” amount, which may or may not be proportionate to the size of the contract requisitioned. Alternatively, seller may want to encourage specific behaviour of potential sellers through the register to buy facility 128. Seller may want to allocate “reward currency” each time a potential buyer indicates interest in the seller's specific goods/services by registering with the register to buy facility 128. For many sellers, this may not be enough. Other sellers may require that potential buyers review an e-mail good/service offering and click on the “ACCEPT COMMUNICATION” button referred to above, or meet with seller before any “reward currency” is allocated. By providing particulars to the system via incentive customization facility 114, user can program the system to allocate “reward currency” automatically with respect to a wide variety of events, including events occurring in the context of, or related to, the register to buy facility 128.

### Incentive Management Facility

The next facility provided by the system described herein is incentive management facility 116. This facility tracks every transaction for each user and credits or debits a user profile corresponding to each such user provided by database 110. The incentive management facility 116 co-operates with incentive customization facility 114 in particular, so as to in further co-operation with computer 17 process transactions occurring via the system described herein in accordance with the incentive programs provided by the incentive customization facility 114, as described above. For example, “reward currency” will be allocated to said user profiles in accordance with the entries made by the user in customizing its incentive program, as also described above.

It is important to understand that in accordance with the invention described herein, incentive management facility 116 updates said user profiles and allocates “reward currency” immediately as soon as an event flagged for a “reward currency” allocation has occurred. This functionality is provided by existing event-driven database management technology which is well-known.

Also, in co-operation with computer 17 and database 110, incentive management facility 116 provides to data structures of database 110 corresponding to each user all information regarding user-related activities processed by the system described herein, such as transaction logs, “reward currency” statements etc. In this manner every event corresponding to desired behaviour, as designated by incentive customization facility 114, is saved to database 110 by incentive management facility 116. Data regarding such events can then be retrieved from database by reporting facility 39, as described below.

In order to meet the objectives of the invention described herein, it is desirable to provide incentive management facility 116 with an override function (not shown). This function can be used either by the user or a system administrator to correct discrepancies in “reward currency” allocations, or to award “reward currency” in accordance with paramaters other than those provided through incentive customization facility 114. For example, the override function could be used by a user to make discretionary awards of “reward currency” to good employees.

### Reporting Facility

The preferred embodiment of the invention described herein also comprises a reporting facility 39. As described above, this facility retrieves data related to transactions processed by the system described herein, and displays said data according to user's selection in a wide range of formats such as web pages, spreadsheets, pie charts etc., in a manner well-known to those skilled in the art.

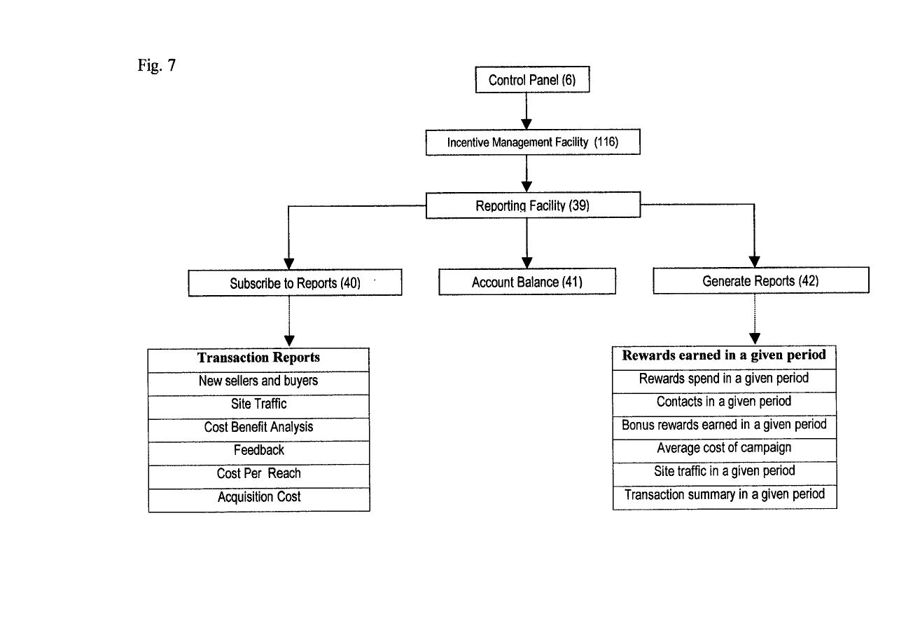

FIG. 7 illustrates by way of example, some of the features provided by reporting facility 39. Using this facility, a user may subscribe to reports 40, obtain account balances 41 or generate reports 42. Again, this information can be obtained in a variety of formats as listed above, depending on user's communicated preference. Also, this information can be accessed on an assortment of web-enabled devices.

With respect to the subscribe to reports function, user will select their desired means of communication of such reports. This selection will be stored in database 110 and thereafter communication facility 124 will communicate said report in accordance with user's selection.

For instance, the user may choose to extract files that determine the levels of reward currency units spend and earned in a given time-period.

### E-Commerce Facility

The system described herein also comprises an e-commerce facility 118 for facilitating e-commerce transactions between users in the server environment.

The e-commerce facility 118 provides a web-based, secure interface that allows participants to select particular goods and services and purchase them through the use of the “reward currency” of the present invention, an internal or external credit card, or a combination of both. In this way the transaction currency used in the e-commerce facility 118 of the present invention can be described as “dynamic” in that goods/services can be purchased using an endless number of different proportions of “reward currency” and traditional currency. Put in another way, the “reward currency” is not only used as a means for acquiring the reward benefits, but as a means of discounting the price of goods/services. This also means that the “reward currency” can be easily applied by the user to more costly goods/services than those traditionally available under incentive programs. These more costly goods/services are also typically more desirable to users. Therefore the perceived value of the benefits derived by the user are greater under incentive programs of the present invention than in prior art incentive programs.

It should also be further emphasized that the “reward currency” can be applied to any good/service offered by the e-commerce facility 118 immediately, regardless of the individual user's current “reward currency” balance.

This maximizes the “immediacy effect” of incentive programs provided by the present invention, thereby improving the effectiveness of such incentive programs and the system overall, because the more direct the incentive the better the result in encouraging desired behaviour. An incentive is more direct when the benefits of such incentive can be realized by the user soon after the required behaviour has occurred, and in a manner that the user is conscious of the behaviour which has resulted in the incentive being accorded.

The first objective is achieved by the present invention, because any allocation of “reward currency” provided for by the system described herein, in the manner described above, will be immediately credited to the user by operation of incentive management facility 116. As particularized below, the benefits of such allocations are also immediately reflected in e-commerce facility 118. These features combined with the “dynamic” nature of the “reward currency” provided herein present a degree of immediacy to the rewards provided by the present invention that are not present in any prior art systems or reward programs.

The e-commerce facility 118 provides an on-line mall. A user can navigate through the on-line mall in a variety of ways. Brand name search engines, price range search engines, good/service description key word search engines and directories are all provided to users. In addition, the on-line mall interface will provide graphic representations of stores, including perhaps the ability to obtain a three-dimensional video stream that simulates a walk around the mall. It should be understood that all manner of tools for locating web content for navigating within the on-line mall are contemplated for use by this invention.

It should also be understood, that the on-line mall also contemplates providing links associated with stores or products providing background information required for informed purchase decisions, or possibly hyperlinks to web sites of the good/service providers, or to consumer reports on products etc.

Still further, e-commerce facility 118 will also provide on a regular basis a graphic interface with an actual person who can be engaged through text, voice and/or web camera to act as a shopping consultant as user navigates through the on-line mall. The user will be able to pose questions to the shopping consultant on where to find certain products, redemption values etc. in real time on-line.

The web page will also contain advertising that has been tailored according to the profile of the individual user, in a manner well-known to those skilled in the art.

Once the user has sufficiently navigated his/her way down to the exact product s/he wishes to examine, they will see on their screen a visual representation of the product or service (if applicable), and a brief description of the good or service. The server will also present web pages indicating the cost of the product in “reward currency” which is equal to its value in traditional currency.

Most importantly, in co-operation with incentive management facility 116, the server will also display in relation to each good/service in on-line mall, the current balance of “reward currency” present in the user's account located in database 110. Through a series of dialogue boxes and drop-down menus, the user will be able to select the quantity of the particular item they want, when they wish for a service to be performed, what proportion of the price they wish to pay in “reward currency”, and what proportion they wish to pay by internal or external credit card.

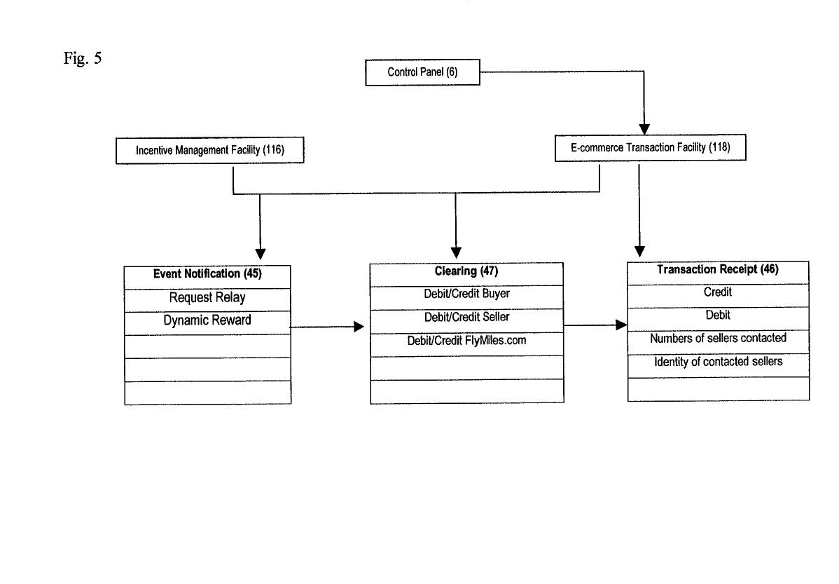

After all the information has been provided by user, user will be prompted to confirm (and perhaps re-confirm) transaction. Once such transaction is confirmed, it will be processed in co-operation with computer 17 and, again, incentive management facility 116 will immediately allocate any applicable “reward currency”. Accordingly, “Clearing Routine” 47 is engaged. This routine is provide in co-operation by incentive management facility 116 and e-commerce facility 118, as best shown in FIG. 5.

“Clearing Routine” 47 processes the debit/credit of “reward currency” in the user accounts provided by database 110. Also, where at least some of the transaction is paid for by internal or external credit card, “clearing routine” 47 will process the credit card transaction.

In addition, an electronic “Transaction Receipt” 46 is sent to user electronically via communication facility 124. The electronic “Transaction Receipt” 46 will comprise confirmation of date of transaction, currency exchanged (how much of traditional currency, how much of “reward currency”), “reward currency” allocation resulting from transaction, delivery terms and so on.

For the sake of clarity, and as illustrated in FIG. 5, every event occurring in the system environment results in an “Event Notification” 45 which is saved to the appropriate data structures in database 110 thereby ensuring proper allocation of “reward currency” in accordance with customized incentive programs and “Clearance Routine 47”. “Event Notification” further ensures the integrity of user's accounts held with system operator, and also the data which is utilized both by reporting facility 39 is further included in the database 110 that forms the basis for the modeling provided by interactive demonstration facility 122.

The user will also be able to purchase more “reward currency” at any time if they so desire.

It should be understood that by means of the “reward currency” of the present invention, many other traditional financial processes can be provided in regard to such “reward currency”, such as “reward currency” lines of credit, overdrafts or the like.

### Interactive Demonstration Facility

The system described herein still further comprises an interactive demonstration facility 122. This facility comprises statistical modeling means based on algorithms designed for predicting the effectiveness of incentive programs by their application to a database comprising data related to the parameters of completed incentive programs, in a manner well-known to those skilled in the art. The results of the modeling can be displayed in a variety of means such as spreadsheet, pie chart, graphs etc.

### Communication Facility

Lastly, the system described herein comprises a communication facility 124 for providing means for the extensive communication between the system, system operator and users described above. Communication facility 124 provides means for communication via e-mail to personal computer, web-enabled devices; voice mails generated by text-to-speech engines; computer-initiated facsimile messages; automated video file messages etc. Communication facility 124 can be engaged automatically the server of the present invention, or by means of control panel 6 whether by means of input by user to any computer peripheral, including voice activated web-enabled devices.

Communication facility 124 also provides means for generating e-greetings, follow up communications and the like, including on an automated basis.

The communication facility 124 is a central messaging point that enables communication between users and the overall system administrator. It allows for e-mail communications through the e-mail messaging area to be sent to and from the various users on the system. It is a way to access the system via a portable devices interface such that users are enabled to solicit business, connect to established accounts, receive critical information and respond via said portable devices.

It should be understood from the above, that the present invention constitutes a combination of three key elements in a single on-line reward environment not found in any prior art systems, namely the elements of utility, choice and immediate rewards. It is well-known in marketing that utility, choice and rewards contribute to customer loyalty. The “immediacy effect” of the “reward currency” of the present invention has been discussed at length above. In addition, because of the use of “reward currency” in combination with traditional currency, customers can be offered considerable choice in the goods/services for which their rewards can be redeemed. Lastly, the present invention provides an environment with utility to users by providing tools for finding business partners and transacting business with such partners. The present invention provides all three of these elements and therefore provides means for achieving significant levels of customer loyalty.

Other variations and modifications of the invention are possible. For the purpose of describing the present invention, aspects of the system have been described as distinct elements. It should be understood, however, that some of the functions of some of these elements may be combined into a single element, such as a software program or module thereof, without departing from the spirit of the invention. For example, incentive customization facility 114 and incentive management facility 116 might easily be combined into one element and still fall within the scope of this invention.

In the present invention, various types of data are required and generated which have, for the purposes of the present description, been subsumed into one database. It should be understood that various databases might be obviously associated with the present invention, as well as numerous data structures might be provided for storing and providing the data referred to herein in a useful manner. Some external data such as credit information regarding users, product information etc. might also be made accessible via the system described herein without adding to or improving on the current invention. In addition, numerous knowledge management systems and/or database management systems might be employed for managing said data and/or extracting useful information therefrom.

The software providing the instructions to web server 100 thereby providing the functionality described herein can be programmed in a number of programming languages, in accordance with knowledge readily available to software architects, engineers and programmers with ordinary skill in their respective arts.

Further, known applications that automatically track and measure response rates, and effectiveness of incentive programs in order to discover buying patterns and changes in customer behaviour can also be associated with the present invention.

It would still further be within the spirit of the present invention to provide personalized e-mail campaigns in association with, for example, the launch incentive program facility 120.

It is also envisaged by the present invention that the “reward currency” of the present invention may be distributed outside of the system environment using, for example, identification cards, smart cards, electronic gift certificates, reward based payments cards etc.

Also, the present invention contemplates use of various aspects of push technology. For example, a user may request that information be sent automatically through a medium of choice at specified intervals. Customized applications will also provide incremental updating. With this application, registered users can be notified anytime something changes on a site—or part of a site—they are interested in. Second, using a user preference profile, a push service monitors sources, looks for matches, and forwards the information. Third, through “automated pull”, entire web pages will be sent based on the user's preference configuration. Fourth, through “automated push” a user subscribes to this service where a web-polling application will send periodic requests for information. Fifth, a user's desktop includes content channels that will constantly broadcast new and time-sensitive options to earn reward currency.

Still further, reward-based auctioning including reverse auctioning can be provided within the environment created by the system disclosed herein. Registered users will be able to auction goods and services using “reward currency” and/or traditional currency.

Lastly, the present invention over time will result in the creation of a cohesive web community. A wide variety of tools for strengthening such communities may be added on to the present invention without departing from the spirit thereof. Such tools include chat rooms, on-line photo albums etc.

I claim:

1. A system for creating and implementing incentive programs for use by a plurality of users corresponding to a plurality of interconnected computers comprising:
a server computer accessible by means of said plurality of interconnected computers, said server computer comprising:
(a) an incentive customization facility accessible to said plurality of users who are authorized to access said incentive customization facility, said incentive customization facility providing means for designing, creating and implementing incentive programs based on a reward currency; and
(b) an e-commerce facility that permits the processing of electronic transactions by said plurality of users authorized to access said e-commerce facility based on said reward currency.

2. A system as claimed in claim 1, wherein said e-commerce facility provides means for processing electronic transactions based on said reward currency and monetary currency.

3. A system as claimed in claim 2, wherein said incentive programs comprise employee programs, business to business programs, and business to end user programs.

4. A system as claimed in claim 3, wherein said incentive customization facility provides means for designing, creating and implementing said incentive programs based on a plurality of incentive program templates provided by said incentive customization facility in co-operation with a database.

5. A system as claimed in claim 4, wherein said incentive customization facility co-operates with said database to provide means for designing, creating and implementing incentive programs based on a series of incentive program parameters, said incentive program parameters comprising target audience data, incentive program start and end dates, and award values attributable to particular events.

6. A system as claimed in claim 5, wherein said server computer further comprises an incentive management facility which provides means for adjusting said incentive program parameters in co-operation with said database.

7. A system as claimed in claim 6, wherein said server computer further comprises a launch incentive program facility which provides means for promoting an incentive program designed, created and implemented by means of said incentive customization facility.

8. A system as claimed in claim 7, wherein said server computer further comprises a communication facility that provides means for communication between said server computer and said plurality of users.

9. A system as claimed in claim 8, wherein said server computer further comprises an interactive demonstration facility providing means for one of said plurality of users authorized to access said incentive customization facility to predict the effect on said target audience of an incentive program designed and created by means of said incentive customization facility.

10. A system as claimed in claim 9, wherein said e-commerce facility further provides means for creating an environment accessible from said interconnected computers for facilitating electronic transactions between said plurality of users who are buyers or sellers.

11. A system as claimed in claim 1 0, wherein said server computer further provides a register to buy facility that permits buyers and sellers to be matched within said environment.

12. A computer product for creating and implementing incentive programs for use by a plurality of users corresponding to a plurality of interconnected computers, said computer product being adaptable to operate in association with a server computer connected to said plurality of interconnected computers, said computer product comprising:
(a) an incentive customization facility accessible to said plurality of users who are authorized to access said incentive customization facility, said incentive customization facility providing means for designing, creating and implementing incentive programs based on a reward currency; and
(b) an e-commerce facility that permits the processing of electronic transactions by said plurality of users authorized to access said e-commerce facility based on said reward currency.

13. A method of designing, creating and implementing incentive programs for use by a plurality of users corresponding to a plurality of interconnected computers comprising the steps of:
(a) providing a server computer accessible to said plurality of interconnected computers, said server computer comprising:
(i) an incentive customization facility accessible to said plurality of users who are authorized to access said incentive customization facility, said incentive customization facility providing means for designing, creating and implementing incentive programs based on a reward currency; and
(ii) an e-commerce facility that permits the processing of electronic transactions by said plurality of users authorized to access said e-commerce facility based on said reward currency;
(b) registering for access to said incentive customization facility and e-commerce facility; and
(c) designing, creating and implementing an incentive program based on reward currency using said incentive customization facility.
